(19) United States
(12) Patent Application Publication
(10) Pub. No.: US 2010/0060580 A1
(43) Pub. Date: Mar. 11, 2010

(54) Computer mouse with less friction

(76) Inventor: Chung-Hsien Lin, Ta-Li City (TW)

Correspondence Address: PHILLIP LIU, 6980, WHITEOAK DRIVE, RICHMOND, BC, V7E 4Z9, CA

(21) Appl. No.: 12/230,814

(22) Filed: Sep. 5, 2008

(51) Int. Cl. G06F 3/033

(52) U.S. Cl. 345/163

(57) ABSTRACT

A mouse includes a casing with a curved top and at least one click pad is located on the curved top of a front end of the casing. A sensing means such as a roller or an optical sensor is connected to an underside of the casing and a plurality of support members are connected to the underside of the casing. Each support member includes a semi-sphere protrusion which is in contact with a desk top by a small area so that the friction between the mouse and the desk top or mouse pad is reduced.

### FIELD OF THE INVENTION

The present invention relates to a computer mouse with four support members on the underside of the mouse and each support member includes a semi-sphere protrusion which contacts the desk top or mouse pad by limited area.

### BACKGROUND OF THE INVENTION

A conventional computer mouse 1 is shown in FIGS. 1 and 2, and generally includes a casing with a curved top 10 and two click pads 12 (only one is shown) located on the curved top of a front end of the casing. A sensing means 2 such as an optical sensor or a roller is connected to the underside of the casing. Four support members 14 are connected to four bases 13 on the underside and located on four corners of the underside of the casing. The bases 13 and the support members 14 protrude from the underside so that a gap is defined between the desk top or mouse pad and the underside of the mouse 1. The support members 14 generally are made by soft material such as fabric and sized around 7 mm in diameter or 6×15 mm oval, which generate significant friction with the desk top or mouse pad when moving the mouse 1. The user moves the mouse so frequently and the friction affects the period that the hand feels fatigue.

In order to improve the shortcoming of significant friction of the conventional mouse, the present invention intends to provide a mouse which includes four support members and each support member includes a semi-sphere shaped protrusion which contacts the desk top or mouse pad by limited area so that the friction is significantly reduced.

### SUMMARY OF THE INVENTION

The present invention relates to a mouse which includes a casing with a curved top and at least one click pad is located on the curved top of a front end of the casing. A sensing means such as a roller or an optical sensor is connected to an underside of the casing and four support members are connected to the underside of the casing. Each support member includes a semi-sphere protrusion which is in contact with a desk top by a small area so that the friction between the mouse and the desk top or mouse pad is reduced.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a bottom view of a conventional mouse;

FIG. 2 is a side view of the conventional mouse in FIG. 1;

FIG. 3 is an exploded view to show the support members and the mouse of the present invention;

FIG. 4 is a bottom view of the support members of the present invention, and

FIG. 5 is a side view of the support members of the present invention.

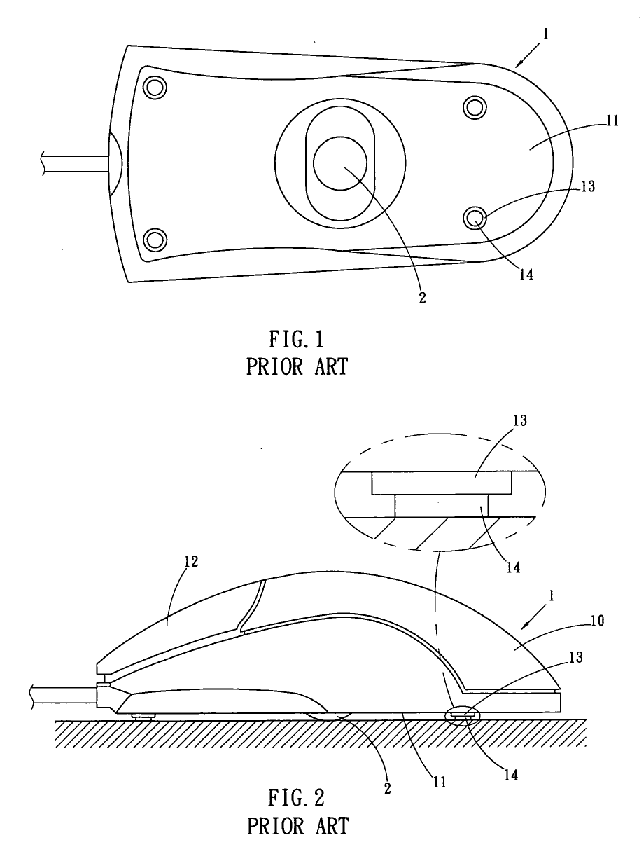

### DETAILED DESCRIPTION OF THE PREFERRED EMBODIMENT

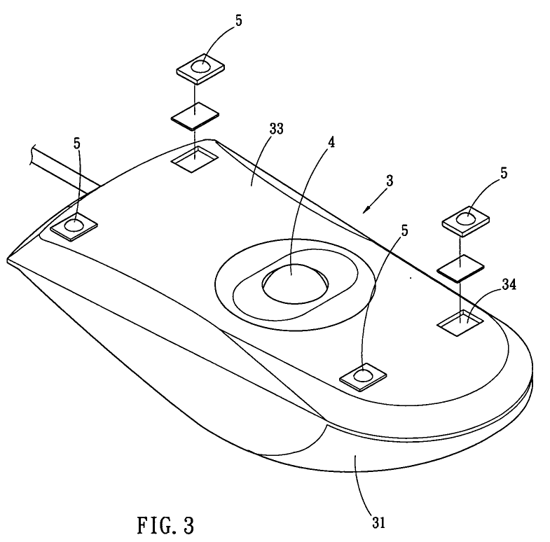

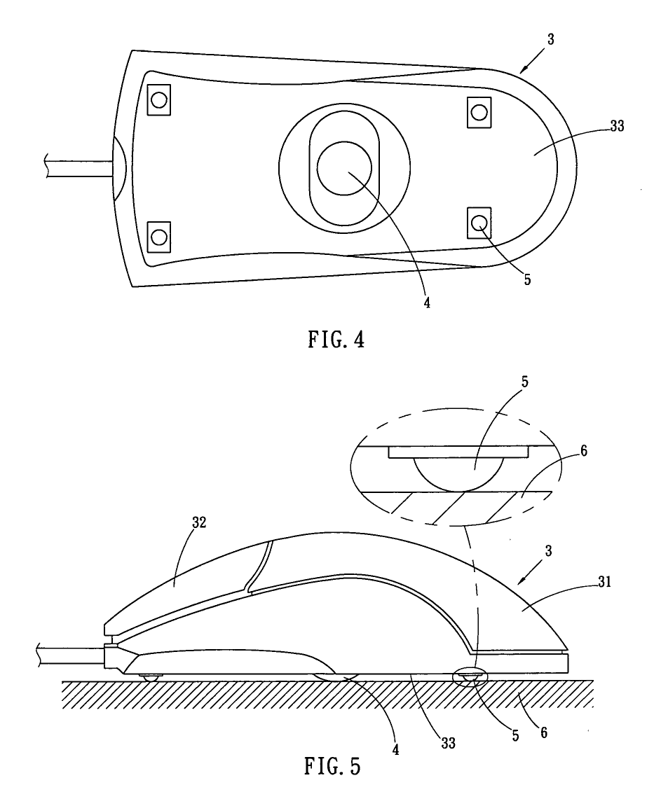

Referring to FIGS. 3 to 5, the mouse 3 of the present invention comprises a casing with a curved top 31 and two click pads 32 (only one is shown) are located on the curved top of a front end of the casing. A wire is connected to the front end of the mouse 3. A sensing means 4 is connected to an underside of the casing and the sensing means 4 can be an optical sensor or a roller. Four recesses 34 are defined in the underside of the casing and four support members 5 are engaged with the recesses 34. Each support member 5 includes a semi-sphere protrusion which is in contact with a desk top 6 or mouse pad. A gap is defined between the support members 5 and the desk top 6 or mouse pad.

The semi-sphere protrusion of each support member 5 is made by material whose stiffness is harder than that of the underside of the mouse 3, such as steel. The semi-sphere protrusion is connected with a rectangular pad which seals the recess 34. The way that the support members 5 connected to the mouse 3 can be any known method such as threading, force-fitting, adhering or even integrally formed with the underside of the mouse 3.

By the semi-sphere protrusions, only very limited contact area is between the semi-sphere protrusions and the desk top 6 or mouse pad, the friction between the support members 5 and the desk top 6 or mouse pad is significantly reduced. The support members 5 preferably are made by stiff and durable material such as metal, such that the support members 5 can be used for a long period of time while maintaining small friction with the desk top 6 or the mouse pad.

While we have shown and described the embodiment in accordance with the present invention, it should be clear to those skilled in the art that further embodiments may be made without departing from the scope of the present invention.

What is claimed is:

1. A mouse comprising:
a casing with a curved top and at least one click pad located on the curved top of a front end of the casing;
a sensing means connected to an underside of the casing, and
a plurality of support members connected to the underside of the casing and each support member includes a semi-sphere protrusion which is adapted to be in contact with a desk top.

2. The mouse as claimed in claim 1, wherein the sensing means is an optical sensor.

3. The mouse as claimed in claim 1, wherein the sensing means is a roller.

4. The mouse as claimed in claim 1, wherein the support members are engaged with recesses defined in the underside of the casing.

5. The mouse as claimed in claim 1, wherein the support members are made by metal.
